(19) United States
(12) Patent Application Publication
(10) Pub. No.: US 2013/0247218 A1
(43) Pub. Date: Sep. 19, 2013

(54) System And Method For Verifying Authenticity Of Documents

(71) Applicants: Nikhil Jhingan, Singapore (SG); Vinod Udharam Vasnani, Singapore (SG)

(72) Inventors: Nikhil Jhingan, Singapore (SG); Vinod Udharam Vasnani, Singapore (SG)

(73) Assignee: Qryptal Pte Ltd, Singapore (SG)

(21) Appl. No.: 13/989,815

(22) PCT Filed: Dec. 2, 2011
(86) PCT No.: PCT/SG2011/000425

§ 371 Date: May 28, 2013

(30) Foreign Application Priority Data
Dec. 9, 2010 (SG) 201009142-9

(51) Int. Cl. G06F 21/60

(52) U.S. Cl. CPC G06F 21/60
USPC 726/27

(57) ABSTRACT

A system and method for verifying the authenticity of documents is provided. The method and system includes incorporating a machine readable code (102, 102a) to the document (101); storing the document and/or other useful information that assists in verifying the authenticity on a secure document verification system (SDVS) (104); the machine code (102, 102a), which contains a secure uniform resource locator (URL) optionally along with other information regarding the document, can then be scanned by a reader (103) such as a camera 103 attached to a computing device for example a smart-phone; the computing device would then, on extracting the URL, redirect to the secure document verification system (104) which then reveals the document and/or relevant information (105) regarding the document which accordingly verifies the authenticity of the document.

### FIELD OF INVENTION

The present invention relates to a system and method for verifying authenticity of documents.

### BACKGROUND

In many transactions, a document needs to be verified/validated for its authenticity. For example when applying for a job, the employer would like to validate the educational certificates presented. When applying for credit facilities, a bank would need to validate another bank's printed statement for such a credit application. Relevant examples could be made for any document of record: pay slips, transaction confirmations, invoices, receipts, licenses, permits, identification cards, etc. This validation need not be with an original document only and could also be needed for a copy of the original document.

Most document authentication systems today involve some form of stenography on a physical document that can be used for verification. A typical approach would be a watermark or a hologram. Some recent approaches in the prior art have suggested various variations of encoding on printed documents. The primary reason is that with advancement and ease of availability of printing technology, it has made it easier to make life-like copies of such documents. As such many of these advancements on printed documents are addressing this issue of maintaining authenticity of documents. However at the same time technology is advancing which makes it easier to create forgeries of these documents which increases the risk of impersonation and fraud. Though generally difficult and cumbersome to use and deploy—these improvements still only address the need to verify a document in the original, there is also a need to verify if a copy is made from the original is authentic as well. Typically this is a time consuming process in verifying it with the document originator or it would typically involve a third party such as a notary public who reviews both the original and copy and certifies that the copy is a “true copy” of the original. Even in such situations, extra steps should be taken to ensure that the “original” document presented is itself not a forgery.

Increasingly, in recent years, documentation is issued and kept electronically. These range from insurance certificates that are purchased over the web, certificates of e-learning, etc. With the advent of such electronic documentation, new ways are needed for verifying the authenticity of such electronic documents as well. Apart from secure verification, for widespread adoption, such a system needs to be easy to use and rely on commonly available equipment.

A method and system is presented here that addresses the above needs.

### SUMMARY

In one embodiment, the present invention provides a secure document verification system. The secure document verification system comprises:
securely storing a document or document related information in electronic format securely; and
generating a copy of the document with a machine readable code added; wherein the machine readable code comprises a secure URL so that the URL extracted from the machine readable code allows presentation of the document for comparison and/or a message on a secure computer system, which along with the other information extracted from the machine readable code, is used to verify the authenticity of the document.

A secure document verification method is also provided. The method comprises of a document issuer/creator storing document information which would be scanned or electronic documents and/or information regarding these documents which could additionally be encrypted, on a secure document verification system. A machine code is then added to these documents which can then be printed out or transmitted on to the document holders. The document holder is now able to present this encoded document to a third party, who is the document verifier. The document verifier would then be able to have the machine code read and processed by an image acquisition device attached to a computing device such as a smart-phone or a computer with a camera, which then leads the party to appropriate system resources to verify the authenticity of the document.

In an embodiment, the document is either scanned from the physical document or is originally an electronic document. This unencoded document is then optionally encrypted using one of many standards based encryption algorithm. According to an aspect of an embodiment, this unencoded document is uploaded to a secure document verification system. Accordingly, in another aspect, the document issuer/creator may ask the system to optionally encrypt the document instead once it has been uploaded to the system. The document issuer/creator then makes a request to the system to generate either machine code itself or to obtain the information to be subsequently generated into the machine code. The request may optionally contain the code expiry, who is permitted to verify this document and if the document is encrypted, provides the encryption algorithm and decryption key. The machine code is then applied to the document and the now encoded document is then either printed out or transmitted on. Optionally the document issuer/creator may request the system to generate the document with the machine code added i.e. encoded document. If so the request could additionally specify the placement location of the machine code on the encoded document.

The machine code contains the secure Uniform Resource Locator (URL) to the document and optionally along with other information regarding the document which assists in verifying the authenticity of the document. The secure URL typically contains at least a record ID which the system uses to refer to the document. If the uploaded document is encrypted the uploaded information may contain the decryption information or it may be embedded in the secure URL.

Accordingly there exist other forms of document information that could be uploaded to the Secure Document Verification System which can be used to verify the authenticity of the documents. One such exemplary embodiment would include, but not limited to, the document issuer/creator may decide to upload the encoded document instead of or along with the unencoded document for verification. Another such exemplary embodiment would include, but not limited to, the document issuer/creator may choose to upload sufficient information to establish authenticity of the document with/without storing the document itself in any form. An aspect of this embodiment is that this information may be optionally stored encrypted on the system and decryption information embedded in the secure URL as well.

Once the encoded document has been obtained, the document issuer/creator would then pass it on to the document holder. The document holder is able to send that along either in electronic format or printed out and handed out for whomever who needs to verify the document. The third party, that is the document verifier, that wishes to verify the authenticity of the document, is able to do so by using a computing device with a camera and appropriate software to read and decode the machine code to extract the information and the secure URL which the computing device would then redirect the user to the secure document verification system. An advantage of this approach is that there exists a variety number of machine codes that allow embedding of information and URLs, such as 2-D barcodes and appropriate software to read such codes, for example, but not limited to, Quick Response Code i.e. QR Codes. Another advantage of this approach is that there exists off-the shelf software both on the desktop computers and mobile devices that are able to interpret these 2-D barcodes such as QR Codes. In particular it is well suited for “smart” mobile devices due to proliferation of such mobile devices with built in cameras. Once the URL is extracted, the computing device may also append location information, such as GPS co-ordinates, to the URL so that they system has knowledge of where the user is scanning the code from. An advantage with this is that the system may tailor the response to the request depending on where the user is coming from.

Once the system receives the request to verify, the system first verifies that the request is valid such as verifying the authenticity of the URL. Once this is verified, the system verifies if there is an expiry for this request code and if so, if it is still valid. Once that has been verified, the system may, if indicated by the request parameters, proceed to identify the user and then determines if the user is authorized to verify the document. An advantage of this process is that the document holder is able to exercise control on the validity of the document with the machine code as well as who is able to verify the authenticity of the document.

Once the system has verified the URL and the request is valid and the user is authorized, it proceeds to decrypt the file or information as per the key and information received by the system from the code reader. If the key is valid, the user may be presented with the unencoded or encoded document for verifying the authenticity of the document. Optionally additional information extracted from the machine code could also be presented to help the process.

In another embodiment, the user may be presented with a message along with sufficient information to establish authenticity of the document. This could be for example, but not limited to, when verifying if a printed bank statement is valid. The printed bank statement, according to this embodiment, would already be encoded with the machine code. The document verifier would, on scanning the machine code and extracting the secure URL, be directed to the secure document verification system and the system then returns information such as, but not limited to, the account holder's name, date of statement and closing balance and any such information that is sufficient to establish the document's authenticity.

Once the process is completed, the system could optionally send out an email notification to all parties that the document has been checked at the date and time specified for record purposes.

The system keeps logs of all activity including the uploading and verification requests of the documents. This is useful for audit trail purposes.

The system could also have features to help automate the verification process eg. the verifier could upload the document that needs to be verified and the system could confirm the match.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

Other characteristics and advantages of the invention will become clearer upon reading one preferred embodiment of the invention made in reference to the attached figures among which:

FIG. 1 illustrates an information flow diagram for verifying the authenticity of a document according to an embodiment of the present invention;

FIG. 2 illustrates a secure document verification system shown in FIG. 1;

FIG. 3 illustrates an information flow diagram for generating or creating an encoded document with a machine readable code added and storing the unencoded document, document information and/or the encoded document on the system shown in FIG. 2;

FIG. 4 illustrates an information flow chart of generating or creating an encoded document with the machine readable code added and storing the unencoded document, document information and/or the encoded document on the system according to an embodiment;

FIG. 5 illustrates the detail of the elements added to a document including an exemplary machine readable code according to an embodiment;

FIG. 6 illustrates examples of secure URLs that are embedded in the machine readable code according to an embodiment;

FIG. 7 illustrates an information flow chart for verifying the authenticity of an encoded document containing the machine readable code according to an embodiment;

FIG. 8 illustrates an image acquisition and processing system according to an embodiment; and

FIG. 9 illustrates a system according to an embodiment.

### DETAIL DESCRIPTION OF PREFERRED EMBODIMENTS

Reference is now made in detail to the description of the embodiments of systems and methods for document verification as illustrated in the accompanying drawings. The invention may, however, be embodied in many different forms and should not be construed as limited to the embodiments set forth herein; rather, these embodiments are intended to describe the present invention to those skilled in the art. Furthermore, all “examples” given herein are intended to be non-limiting. In some instances, well known methods and structures have not been described in detail so as not to unnecessarily obscure the present invention.

According to an embodiment, a document printed with a machine readable code that embeds a secure Uniform Resource Locator (URL) to a validation resource makes it easier to verify the authenticity of a document.

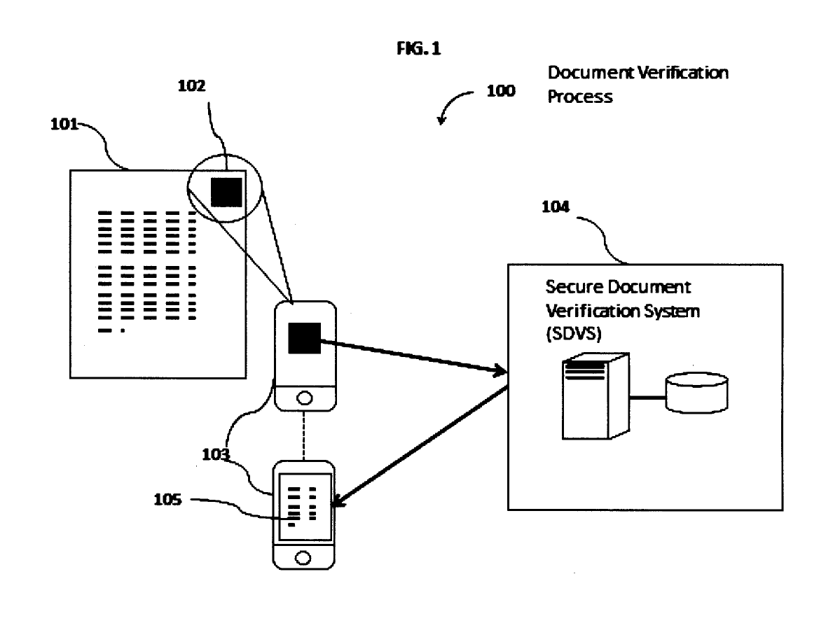

FIG. 1 is a diagram of a document verification process 100 according to an embodiment of the present invention. As shown in FIG. 1, an encoded document 101 may be a scanned document of a physical document or an electronic document and may be in various formats for example, but not limited to, the ubiquitous PDF format. The encoded document 101 has on it a machine readable code 102. This machine readable code 102 could be in various formats, for example, but not limited to, Quick Response (QR) Code which is a form of 2-D bar code or its equivalent. Such codes are typically read by a device such as a smart mobile phone 103 with a camera or a computer equipped with a camera (not shown) and with appropriate software is able read the machine readable code 102. The machine code 102 is read and interpreted by a computer program which reveals the information encoded within the machine code. Such information could include for example, but not limited to, meta information about the document as well as an Uniform Resource Locator (URL). The URL, with embedded security, points to a resource on a Secure Document Verification System (SDVS) 104. The SDVS 104 may, if required, ask the document verifier to identify him/herself via an email verification process and/or additionally via other factors such as a phone/SMS verification process. The document verifier is then presented on the screen 105 of the same device 103 information that helps to ascertain the authenticity of the document 101. The information presented may be the scanned or electronic document as stored by the issuer/creator with and/or without the machine readable code added to compare against, or it may be a message along with sufficient information from the document issuer/creator indicating that the document is verified to be authentic. This information returned from the SDVS 104 along with the meta information extracted from the machine code provides sufficient information to the document verifier to verify the document's authenticity. The document verifier may optionally be able to request for an email confirming the date and time it was checked. The SDVS 104 may be hosted by the document issuer/creator or by a trusted third party service to verify the authenticity of the document.

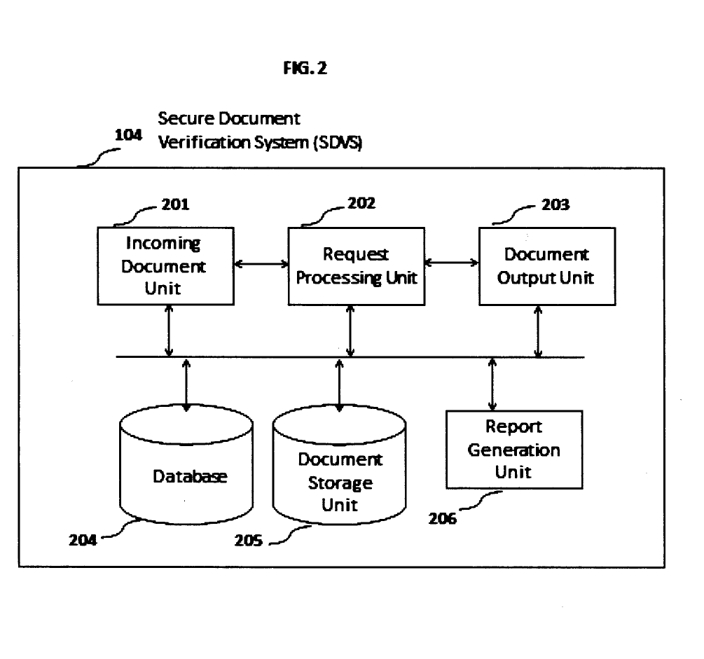

FIG. 2 illustrates an exemplary block diagram of the Secure Document Verification System (SDVS) 104 shown in FIG. 1. As shown in FIG. 2, the SDVS 104 includes the following units: an Incoming Document 201, a Request Processing 202, a Document Output 203, a Database 204, a Document Storage 205 and a Report Generation 206. The Incoming Document Unit 201 receives the unencoded or encoded documents. All documents are stored securely on the Document Storage 205 unit on which the document information could be stored as it is or optionally encrypted. These incoming documents may additionally be encrypted. Optionally it may be encrypted with a unique key for each document for added security and the key embedded in the secure URL. The Database 204 has the necessary tables to keep track of the incoming documents. The Request Processing Unit 202 processes all incoming requests for both incoming and outgoing documents as well as requests for storing and retrieving document information pertaining to verifying the document's authenticity. This document information may also be stored encrypted. The Request Processing Unit 202 interacts with the Database 204 to store and retrieve this document information as well as capture meta information such as request parameters and other such relevant information pertaining to these documents. The Request Processing unit 202 also interacts with the Document Storage Unit 205 for storing and retrieving documents. It also handles the decryption of documents if they are encrypted with a unique key before handing it over to the Document Output Unit 203. The Document Output Unit 203 proceeds to retrieve the processed document and presents it to the document verifier or displays information making it possible to verify the document's authenticity. In situations where a request is made to generate an encoded document 101 with the machine code 102 added, the Request Processing Unit 203 does the needful by extracting the document out, decrypting if necessary, and adding the machine code 102 on the location specified and the Document Output Unit 203 would then return the encoded document 101 back to be forwarded onwards to the document verifier. All the units in the SDVS 104 log all events and processes in appropriate database tables. The Report Generation Unit 206 makes use of this event logs to generate various reports, these include, but not limited to, who has uploaded a document, when and who has requested verification for which document and if it was successful.

As mentioned above, both encoded and unencoded documents as well as document information could optionally be stored encrypted. This encryption process could be done by the document issuer/creator or document holder prior to uploading the document. Alternatively they could request the system to encrypt the documents and/or information on their behalf and to return the key and algorithm used. The Request Processing Unit 202 will then do the needful to process the encryption request.

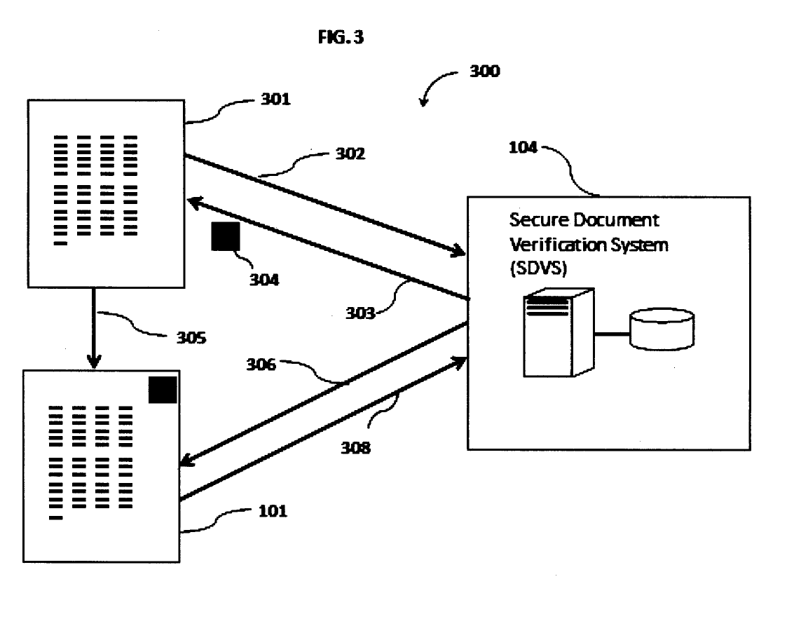

FIG. 3 illustrates an information flow diagram 300 for generating or creating an encoded document with machine code and storing the unencoded document, document information 301 and/or the encoded document 101 on the SDVS 104. The document issuer or creator may initially choose to upload 302 the unencoded document and/or document information 301 to be stored securely on the SDVS 104. The document issuer/creator may then choose to request 304 for the machine code or request 303 information necessary to generate the machine code to be added 305 to the document to create the encoded document 101. In addition, the document issuer may optionally store 308 the encoded document back on to the SDVS 104 along with the earlier uploaded 302 unencoded document and/or document information 301.

Alternatively, the document issuer/creator, without initially storing document or document information, may request 304 for the machine code 102 or request 303 information necessary to generate the machine code 102 to be added 305 to the document to create an encoded document 101. The document issuer/creator may then choose to just store 308 the encoded document 101 instead.

Also alternatively, if the unencoded document 301 is stored 302 on the SDVS 104, the document issuer/creator may request the system to generate the encoded document 101 with a machine code added 305 and an electronic version of the document with the machine code 101 added is returned back 306 to the document issuer/creator. A copy of the encoded document 101 may also be optionally stored 308 on the SDVS 104 as well.

The encoded document 101 can then be printed or forwarded on to the document holder. This encoded document 101 can then be given out to other parties i.e. document verifiers either directly by the document issuer/creator or through document holders who can then verify the authenticity of the document by means of a computing device with an image acquisition device that is able to read and process the machine code.

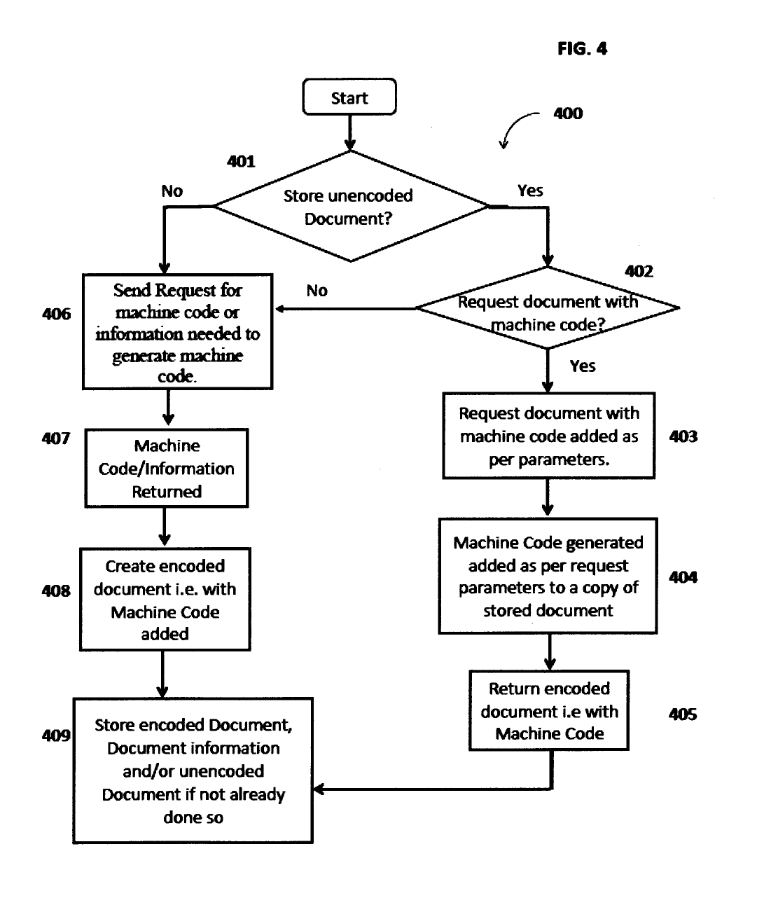

FIG. 4 shows a detailed information flow chart 400 of the process 300 illustrated in FIG. 3. A document may be initially stored on the SDVS 104. If the document is already available in an electronic format, it can be directly provided to the SDVS 104 or else a physical document would be scanned and then stored on SDVS 104. This document could optionally be stored encrypted whereby the encryption process is done by document issuer/creator or document holder prior to uploading the document or they could have the SDVS 104 encrypt the document on their behalf and to return the key and algorithm used.

If the document is stored on the SDVS 104, the document issuer/creator or document holder could choose one of two possible scenarios, as shown in FIG. 4, which is either to request 406 the SDVS 104 for an encoded document 101 with the machine code 102 or the alternative is to generate the encoded document on their own by requesting 402 the SDVS 104 to provide the necessary information to generate the machine code 102.

If it is chosen for the SDVS 104 to generate 402 the encoded document 101, a request can be made for the system to generate 403 an encoded document with machine code added. Various options can be specified in such a request including, but not limited to, determining the placement of the machine code within the document as well as the expiry of the machine code and who is able to verify the document's authenticity. The URL encoded in the machine code could optionally have the file decryption key and algorithm used embedded in it if the stored document is encrypted. The machine code 102 is then added 404 to the document as per the request parameters. The encoded document 101 with the machine code 102 added is then returned 405 to the document issuer/creator or document holder who can either print it out or forward it electronically. In addition, optionally the encoded document 101 along with any additional document information can be uploaded 409 to the SDVS 104 for use in the verification process.

If the decision in step 402 is not to generate the encoded document 101 or the decision in step 401 is not to store the unencoded document on the SDVS 104, a request 406 is made for just the machine readable code 102 or the information needed to generate the machine code 102. This request may include optional information such as, but not limited to, an expiry on the request, who can verify the document as well as any meta information that should be included in the machine code 102 that would assist in verifying the document. If the document is stored encrypted, the request should include the encryption algorithm and the key needed to decrypt the file that should be embedded in the secure URL. The SDVS 104 would then return 407 the either machine code or the information needed to generate the machine code as requested. The document issuer/creator or document holder would then be able to create the encoded document 101 with the machine code 102 added 408 using common industry standards document processing tools.

The document issuer/creator or document holder would then need to store the document (encoded or unencoded) and/or document information on the SDVS 104 as is required to ascertain the document's authenticity. The document and/or information can be optionally stored 409 encrypted, and if so the key and algorithm should be the same as that was specified in the request 406 to generate the machine readable code 102.

The machine code 102 need not be static, it can be dynamically generated so that the same document may have different machine readable code at different times where the human readable content is the same but the machine readable code is different. For example, but not limited to, the document issuer/creator or document holder can ask the SDVS 104 to generate 403 an encoded document with a different machine code added with different set of parameters such as placement of code, expiry and who is able to verify the authenticity and the like. Alternatively the document may have a static machine code 102 and the document issuer/creator or document holder is able to vary the expiry and who can verify the document on the SDVS 104 itself, thereby providing flexibility as to who and when the same document with the machine code 102 can be given out without the need to generate a new copy with a new machine code added.

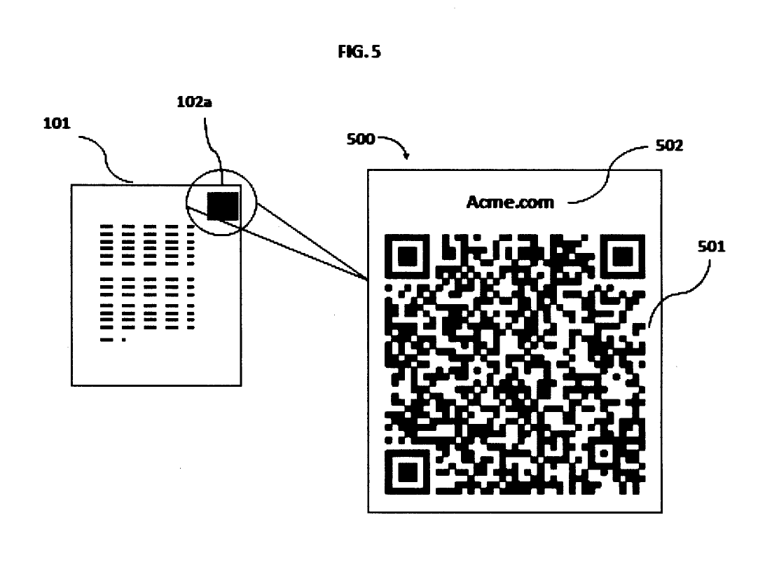

FIG. 5 illustrates in detail 500 a machine code 102a added to an encoded document 101 according to another embodiment of the present invention. An exemplary machine readable code 501 is illustrated in FIG. 5. This machine readable code could be of various formats, for example, but not limited to Quick Response (QR) Code as illustrated in this exemplary embodiment. However it would be apparent to one of ordinary skill in the art that any equivalent machine readable code may be used. In addition the SDVS 104 may optionally print, in human readable text, the domain 502 of the URL encoded within the machine code 102a. This domain 502 is typically printed in the vicinity of the machine readable code 501. The document verifier will then be able to additionally verify that the printed domain 502 matches the URL when redirected to SDVS 104, thereby providing an additional security measure against common web exploits such as phishing and the like.

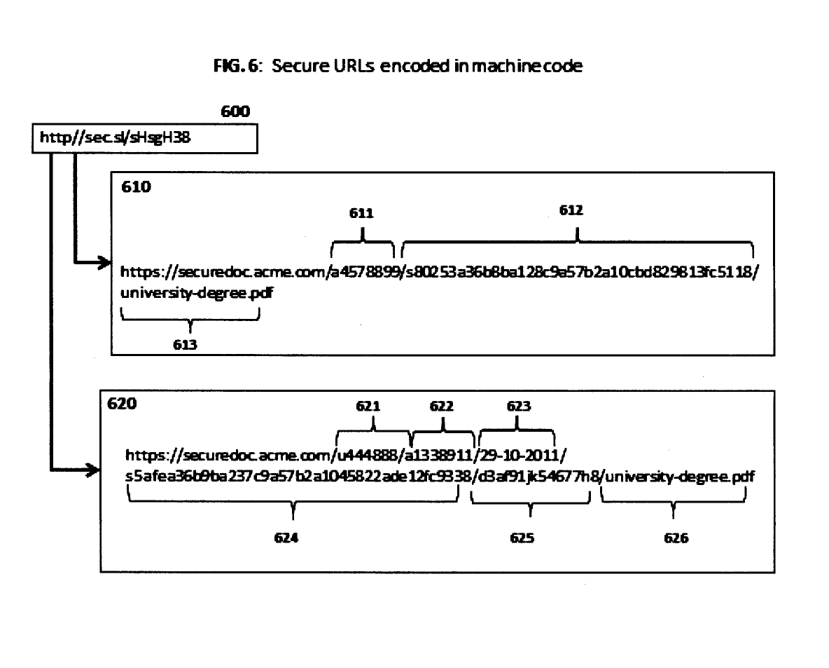

FIG. 6 shows URL samples that could be encoded in the machine readable code 501. A redirection service could be used to shorten the URL 600 so that, with less information to encode, the machine code 102a would be smaller in size allowing for flexibility as to the placement of the code on the document. This shortened URL 600 would then redirect to the secure URL 610, 620. The document issuer/creator could choose to forgo the URL redirection service and to encode the machine code 102a with the secure URL 610 or 620. In practice, the shorter of the two URLs 610 presented in this example could be used. As shown in FIG. 6, the URL has the following features, including but not limited to:
Record id 611, which identifies who has requested this copy of the document with this particular machine code.
A cryptographic hash 612 of the parameters with a shared secret key on the SDVS 104. The record id 611 identifies the key used by the SDVS 104. This helps to ascertain the data integrity as well as the authenticity of the URL message. Such examples of URL hashes are well known to those familiar with the art. Examples include, but not limited to Hash-based Message Authentication Code (HMAC) and the like. Any cryptographic hash function could be used such as MD-5 and SHA-1.
The document file name 613.

With this URL 610, the meta information for example, but not limited to, code expiry and who is able to verify the authenticity of the document are managed on the SDVS 104 itself. The record id 611 provides a pointer as to extracting the necessary meta information on the SDVS 104. This method provides for flexibility for the document issuer/creator in varying the parameters such as code expiry and who can verify the authenticity and the like.

Alternatively the URL 620 encoded in the machine readable code 501 may specify additional meta information rather than have it tunable on the system such as code expiry etc. As shown in FIG. 6, the URL 620 presented here has these following features, including but not limited to:
Document issuer/creator id 621, which identifies who has requested this copy of the document with this particular machine code.
A Record id 622, which points to meta information on the SDVS 104 for this particular machine code, which includes, but not limited to, the who is authorized to verify this document, its expiry and the like.
An expiry date 623 which is part of the cryptographic hash 624 so that it can be verified that it has not been tampered with.
A cryptographic hash 624 of the parameters above with the shared secret key (as determined by the record id 622 on the system). This helps to ascertain the data integrity as well as the authenticity of the URL message. Such examples of URL hashes are well known to those familiar with the art. Examples include, but not limited to Hash-based Message Authentication Code (HMAC) and the like. Any cryptographic hash function could be used such as MD-5 and SHA-1.
If the file and/or document information stored is encrypted, an embedded decryption key and algorithm 625 could optionally be specified. This is used by the SDVS 104 to extract the decryption key and the algorithm to be used to decrypt the file and/or information on the system when presenting the stored unencoded document, encoded document and/or document information for verification. This method provides a unique encryption key for each document and/or document information stored on the system thereby enhancing security as the system need not be aware of the method and key used. Various encryption methods could be used, including but not limited to for example AES, Blowfish and the other popular methods.
The document file name 626.

It would be known to those skilled in the art, that various modifications can be made to the described secure URLs without departing from the scope of the claimed embodiments and thereby generating various such secure URLs that are combination of the features in 610 and/or 620.

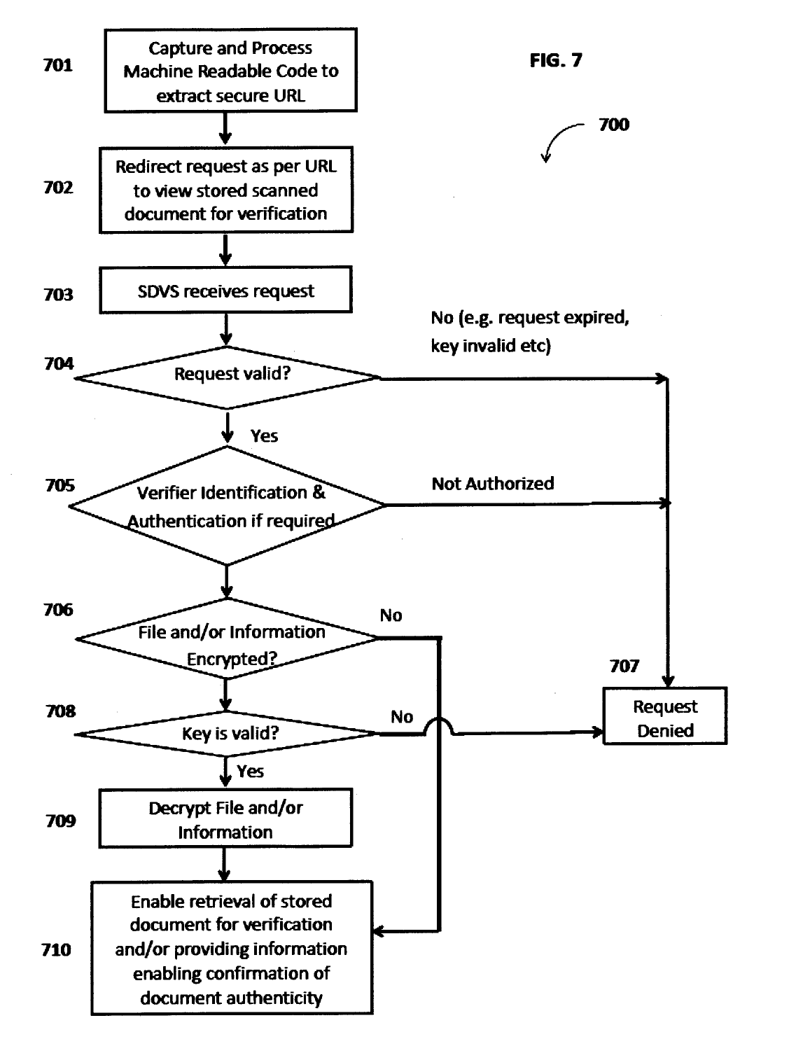

FIG. 7 is a flow chart that lists out the steps for the process 100 as shown in FIG. 1. As shown in FIG. 3, a reader device 103 that has a camera captures and processes 701 the machine readable code 102, 102a to extract the secure URL 701. The reader device 103 then redirects the request 702 to the Secure Document Verification System (SDVS) 104 using a secure protocol such as HTTPS. The SDVS 104 on receiving 703 such a request first proceeds to check 704 if the request is valid. A series of checks may include, but not limited to, checking if the cryptographic hash is valid and checking if request has an expiry and if so if has expired. To assert the validity of the hash, the SDVS 104 proceeds to recreate the hash with the necessary parameters either agreed upon earlier by the document issuer/creator or as specified on the URL along the secret share key retrieved from the SDVS 104 to check if the request is valid. Such hashes in URL could use a variety of standards as described earlier including, but not limited to, such as Hash-based Message Authentication Code (HMAC) and the like. If it is found that the request is invalid, the request is rejected 707 and an error message is displayed. If the request is valid, it proceeds to check 705 if this code requires that the document verifier to identify and authenticate before proceeding. This includes checks if the user is authorized to view this document, as the particular encoded document sent out may be optionally restricted to only allow certain parties to view and assert its authenticity. If these checks are needed and the checks 705 indicate that the document verifier is not authorized to verify this document, the request is denied 707. If the user is authorized or no authorization checks are necessary, the system then checks 706 if the stored document and/or document information stored is encrypted. If it is encrypted it checks 708 if the key obtained from the URL is valid. If it is not valid, it denies the request 707. If the key is valid, the SDVS 104 proceeds 709 to decrypt the file and/or information. Once the file and/or information has been decrypted or if the file and/or information is not encrypted it proceeds 710 to display the stored document and/or presents a message that asserts the document's authenticity. The output of the SDVS 104 may also differ based on any geographic location information provided in the URL, if available. The SDVS 104 may optionally send out an email notification to all parties that the document has been verified at the date and time specified for record purposes

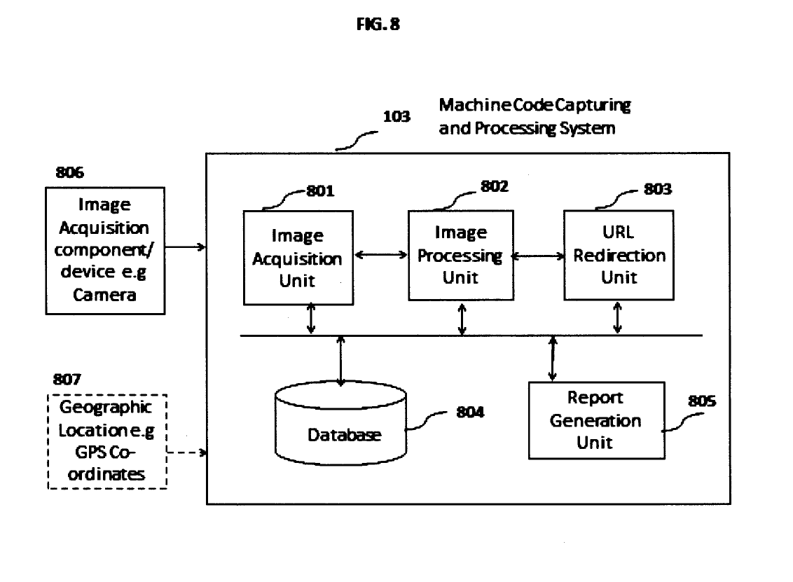

FIG. 8 illustrates an exemplary block diagram of a machine code capturing and processing system 103 shown in FIG. 1. As shown in FIG. 8, the machine code capturing and processing system 103 includes an image acquisition component or device 806, examples of which include but are not limited to, cameras, scanners and the like. Such a device 806 should be able to scan the machine code 102, 102a and pass it on an image acquisition unit 801. The Image Acquisition unit 801 may pre-process the image, for example, to correct any errors found in the image and then pass it on to an Image processing Unit 802. The image processing unit 802 then proceeds to decode the image and extract the URL found in the machine code 102, 102a. Finally an URL Redirection Unit 803, proceeds to redirect the user to the appropriate using the URL. The URL Redirection Unit 803 may append 807 the geographic location or GPS co-ordinates to the URL request, if it is available.

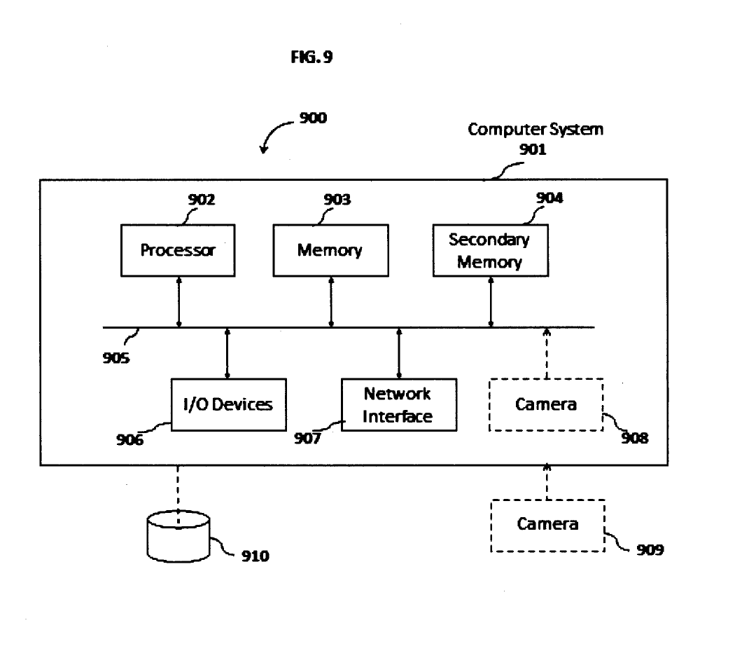

FIG. 9 illustrates an exemplary block diagram of a system 900, which embodies the computing device 103 that is part of the Secure Document Verification System (SDVS) 104 or the computing device 103 with the camera capable of reading and processing the machine code 102, 102a such as the device in FIG. 1. The system 900 includes a computer system 901. The computer system 901 includes one or more processors, such as processor 902 providing an execution platform for executing software. Commands and data from the processor 902 are communicated over a communication bus 905. The computer system 901 also includes a main memory 903, such as Random Access Memory (RAM), where software maybe resident during runtime and a secondary memory 904. The secondary memory 904 includes, for example, a hard disk drive and/or a removable storage drive, representing a USB thumb drive, a compact disk drive etc. In addition to the storing software, the memory storage 903 and 904 may be used to store any information for generating a machine coded document as described in the embodiments above.

A user interfaces with the computer system 901 with one or more I/O devices 906, such as a keyboard, a mouse, display and the like. A network interface 907 is provided for communicating with other computer systems or mobile device via a network. For example, the network interface operates as a transmitter and receiver. The interface 907 may be used to receive documents to be machine coded and for sending the documents back to the document holder. It is also used to receive requests for viewing documents by mobile devices and other computer systems to decode the machine code on the document.

A camera 908 may be present within the computer system 901 such as on a mobile device 103 or attached externally 909 as an I/O Device 906. The camera is used to capture the machine code 102, 102a on the document and appropriate software is then able to interpret the machine code and redirect the request for the document to SDVS 104.

External storage systems 910 such as Network Attached Storage (NAS) or Storage Array Networks (SANS) as needed may also be added to the computer system 901 as required by the SDVS 104. This could be used for example, but not limited to, database and storage of scanned secure documents and the like.

One or more of the steps of the methods shown in FIG. 4 and FIG. 7 and other steps described herein may be implemented as software embedded on a computer readable medium, such as the memory 903 and/or 904, and executed on the computer system 901, for example, by the processor 902. The steps may be embodied by a computer program, which may exist in a variety of forms both active and inactive. For example, they may exist as software program(s) comprised of program instructions in source code, object code, executable code or other formats for performing some of the steps. Any of the above maybe embodied on a computer readable medium, which include storage devices and signals, in compressed or uncompressed form. Example of suitable computer readable storage devices include conventional computer system RAM (random access memory), ROM (read only memory) and magnetic or optical disks. Examples of computer readable signals, whether modulated using a carrier or not, are signals that a computer system hosting or running the computer program may be configured to access, including signals downloaded through the Internet or other networks. Concrete examples of the foregoing including distribution of the programs on a CD ROM or via Internet download. In a sense, the Internet itself, as an abstract entity, is a computer readable medium. The same is true of computer networks in general. It is therefore to be understood that those functions enumerated below/therein may be performed by an electronic device capable of executing the above-described functions.

It will be apparent to one of ordinary skill in the art that the system 900 is meant to illustrate a generic system and many conventional components may be used in the system 900 that are not shown.

While the embodiments have been described with reference to examples, those skilled in the art will be able to make various modifications to the described embodiments without departing from the scope of the claimed embodiments.

What is claimed is:

1. A secure document verification system comprising:
securely storing a document or document related information in electronic format securely; and
generating a copy of the document with a machine readable code added; wherein the machine readable code comprises a secure URL so that the URL extracted from the machine readable code allows presentation of the document for comparison and/or a message on a secure computer system, which along with the other information extracted from the machine readable code, is used to verify the authenticity of the document.

2. A system according to claim 1, wherein the secure URL further comprises meta information regarding the document.

3. A system according to claim 1, further comprises adding a domain name in the vicinity of the machine readable code where the domain name matches the domain name of the URL encoded in the machine readable code.

4. A system according to claim 1, further comprises specifying the location of the machine code on the copy of the document that is generated with machine code added.

5. A system according to claim 1, further comprises generating and returning the machine readable code which is subsequently added to the document.

6. A system according to claim 1, further comprises returning information necessary to generate the machine readable code which is subsequently added to the document or a copy of the document.

7. A system according to claim 1, further comprises specifying an expiry date for the machine readable code and that the expiry date can be specified and changed on the system or specified on the secure URL.

8. A system according to claim 1, further comprises specifying and limiting parties who are able to verify the authenticity of the document.

9. A system according to claim 1, further comprises encrypting the document file and/or document information before it is stored on the system and the encryption key may be unique per file/information and the encryption method and decryption key to be embedded in the secure URL.

10. A system according to claim 1, further comprises sending a notification email to all or specified parties once a document verification transaction has been completed.
